(19) United States
(12) Patent Application Publication
(10) Pub. No.: US 2011/0230979 A1
(43) Pub. Date: Sep. 22, 2011

(54) SCALABLE AND FLEXIBLE CONTROL SYSTEM HAVING SYMMETRICAL CONTROL UNITS

(75) Inventors: Danny A. Reed, Redmond, WA (US); Suyash Sinha, Snohomish, WA (US); Mohamed E. Fathalla, Sammamish, WA (US); Charles J. Williams, Bothell, WA (US); Boyd L. Hays, Kirkland, WA (US)

(73) Assignee: Microsoft Corporation, Redmond, WA (US)

(21) Appl. No.: 12/727,230

(22) Filed: Mar. 19, 2010

(51) Int. Cl. G05B 13/04; G05B 15/02; G06F 15/18

(52) U.S. Cl. 700/7; 706/12; 700/31

(57) ABSTRACT

A control system is described that includes a scalable collection of one or more symmetric control units. The control units govern separate respective aspects of a target system, such as a data center. Each control unit can include a set of pluggable modules, including learning functionality, decision functionality, event processing functionality, sensor functionality, and actuator functionality. The scalable and extensible nature of the control system allows the control system to be quickly and efficiently deployed in response to changes in the target system being controlled.

### BACKGROUND

Control systems are commonly used to control the operation of complex target systems, such as data centers, manufacturing plants, power plants, and so forth. Different control objectives may apply to different respective target systems. For this reason, a design engineer may decide to build a custom control system to address the unique characteristics of a particular target system. More specifically, in some cases, the design engineer may provide a custom control system that has a fixed topology of control modules. A master control program may specify the manner in which these control modules are “wired” together and the manner in which these modules interact.

The above-summarized approach to deploying a control system has drawbacks. In many environments, such as a data center, the target system being controlled changes on a relatively frequent basis. In this environment, the data center infrastructure provider may wish to expand or contract computing resources (CPU, memory, storage, network, etc) to address a change in customer demand. To address these needs, the design engineer can redesign the master control scheme that is used to control the data center. However, doing so may be technically difficult, time-consuming, prone to errors, or may suffer from all of these drawbacks.

Furthermore, in some environments, a control system may encounter control-scenarios that were not foreseen at the time of design. A control system that uses a rigid master control program may perform poorly in these circumstances. The control program can be redesigned, but, again, this imposes burdens on the design engineer.

### SUMMARY

An efficient, flexible, and scalable control system is described herein for controlling a target system by placing and interconnecting one or more symmetric control units. The control units control different respective aspects of the operation of the target system. Further, each control unit includes one or more pluggable modules (described below). A user can “plug” appropriate pluggable modules into a control unit to enable the control unit to provide a particular manner of operation within a particular level or subsystem of the target system. The illustrative potential merits of the control system are described in the Detailed Description section.

According to one illustrative feature, the control system can be used to control the operation of one or more data centers, potentially distributed across different geographic locations. This enables the data centers to operate in a coordinated fashion.

According to another illustrative feature, an individual control unit can include a number of modules defined by a common architecture. For example, a control unit may include sensor processing functionality for receiving sensor information, as well as actuator processing functionality for controlling at least one actuator associated with the target system, where an actuator is any type of agent that carries out control operations. The control unit can also include decision functionality for controlling the target system to achieve a goal (or goals) specified by a policy; the decision functionality accepts at least one input (such as sensor information received from the sensor functionality) and generates at least one output which promotes the goal (such as appropriate commands provided to the actuator functionality). According to one illustrative implementation, at least one of the decision functionality, sensor processing functionality, and actuator processing functionality corresponds to a pluggable module.

According to another illustrative feature, each control unit may include event processing functionality that facilitates processing of information within the control unit.

According to another illustrative feature, at least one control unit can include learning functionality that dynamically adjusts the behavior of the control unit based on at least one dynamic factor.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative control system for controlling the operation of a target system, the control system including one or more symmetric control units.

FIG. 2 shows an illustrative example of a control system that is used to control the operation of two or more data centers.

FIG. 3 shows an illustrative control unit that can be used in the control system of FIG. 1.

FIG. 4 shows one example of a sensor service module for use in the control unit of FIG. 3.

FIG. 5 shows one example of an actuator service module for use in the control unit of FIG. 3.

FIG. 6 shows one example of an actuator manager module for use in the control unit of FIG. 3.

FIG. 7 shows one example of an event processor module for use in the control unit of FIG. 3.

FIG. 8 is an illustrative procedure that describes one way of setting up and operating a control system.

FIG. 9 is an illustrative procedure that describes one manner of operation of decision functionality used in a control unit.

FIG. 10 shows illustrative processing functionality that can be used to implement any aspect of the features shown in the foregoing drawings.

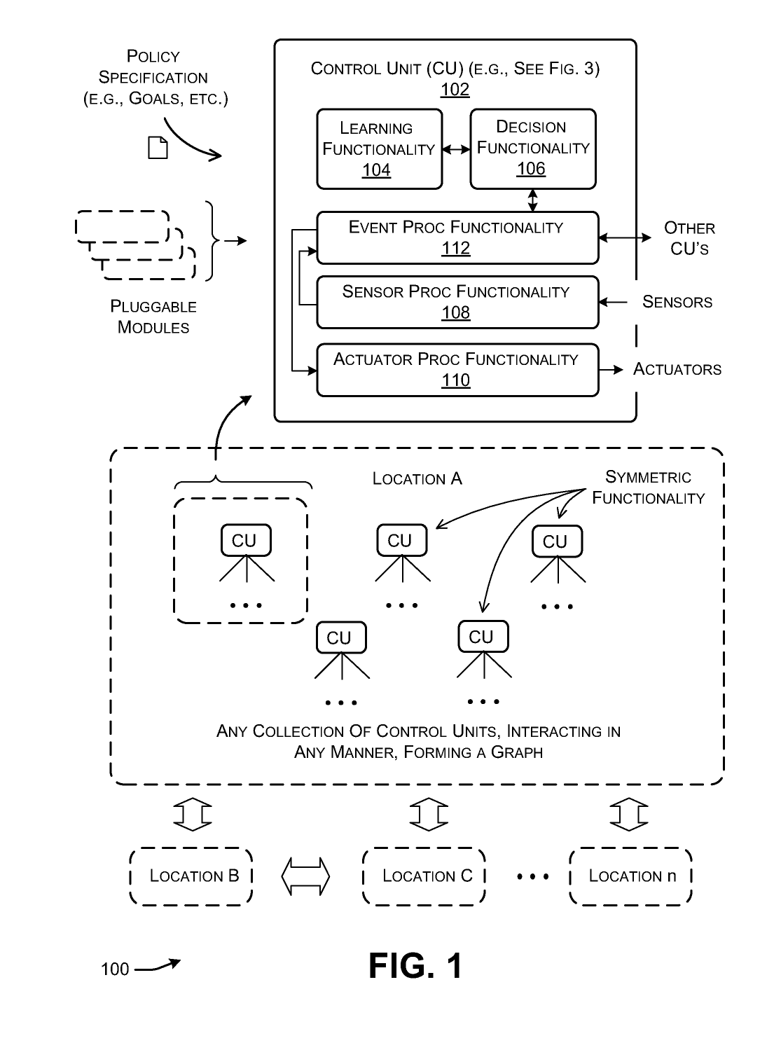

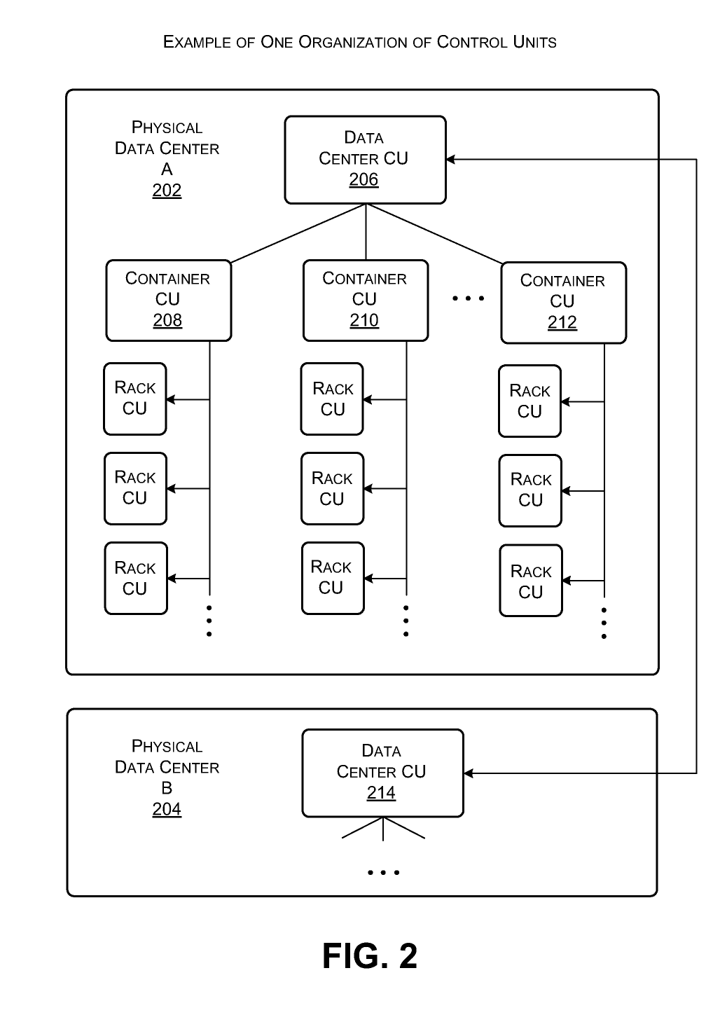

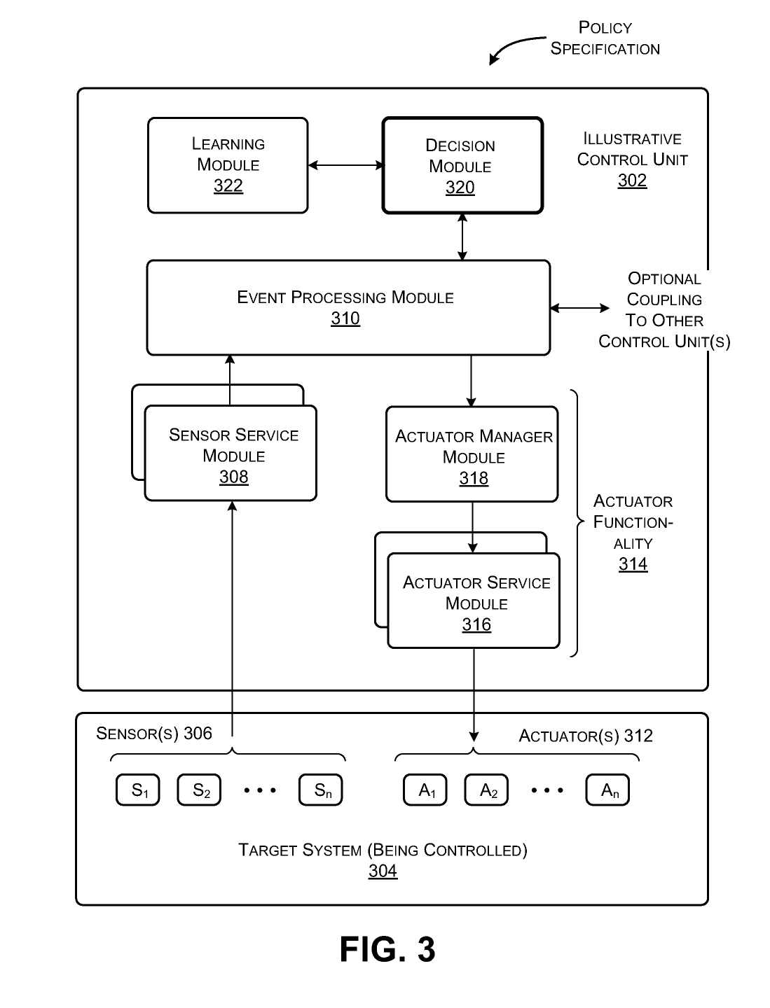

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative control system for controlling any type of target system. Section B describes illustrative methods which explain the operation of the control system of Section A. Section C describes illustrative processing functionality that can be used to implement any aspect of the features described in Sections A and B.

Generally, the Detailed Description sets forth an efficient, flexible, and scalable control system for controlling a target system by placing and interconnecting one or more symmetric control units. The control system is efficient, in part, because each control unit may include a high throughput complex event processing module; further, multiple control units can be connected together to make high throughput decisions at various levels of the target system's operation. It is flexible (e.g., extensible) in the sense that the infrastructure provider can quickly add new modules to any control unit to change the sensor functionality, actuator functionality, decision functionality, learning functionality, etc. for new control scenarios without requiring changes to the control system's fundamental design. It is scalable in the sense that the infrastructure provider can quickly add new control units at different levels within the target system to increase scale without incurring burdensome setup effort; overall capacity of the control system increases as more control units are deployed. Still other potential merits of the control system will be set forth below.

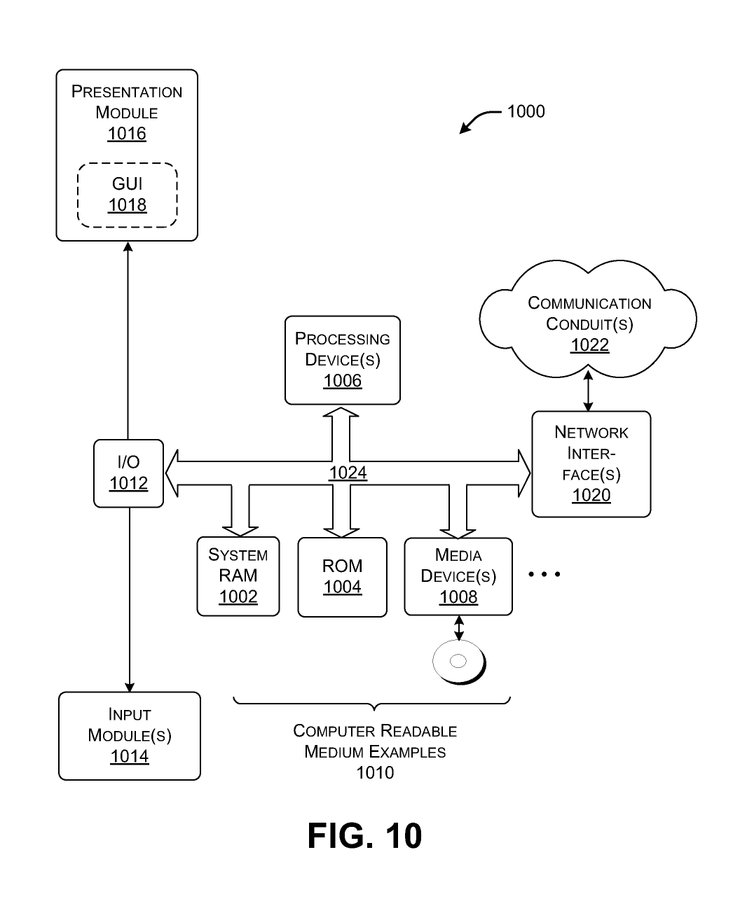

As a preliminary matter, some of the figures describe concepts in the context of one or more structural components, variously referred to as functionality, modules, features, elements, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 10, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

The following explanation may identify one or more features as “optional”. This type of statement is not to be interpreted as an exhaustive indication of features that may be considered optional; that is, other features can be considered as optional, although not expressly identified in the text. Similarly, the explanation may indicate that one or more features can be implemented in the plural (that is, by providing more than one of the features). This statement is not be interpreted as an exhaustive indication of features that can be duplicated. Finally, the terms “exemplary” or “illustrative” refer to one implementation among potentially many implementations.

A. Illustrative Systems

A.1. Overview

FIG. 1 shows an illustrative control system 100 for controlling any type of target system. For example, in one example, the target system may correspond to one or more data centers. In another case, the target system may correspond to a manufacturing system, power plant, and so on.

In some cases, a target system, as this term is broadly used herein, may encompass plural target subsystems, which are referred to, in aggregate, as a single target system. Also, in some cases, the control system 100 may affect the operation of a decision subsystem (e.g., referring to any logic that makes decisions in any environment, such as business logic); that decision subsystem, in turn, may control the operation of another subsystem. Here, the term target system encompasses both the decision subsystem and the ultimate target of control.

More specifically, the control system 100 controls the manner of operation of equipment within the target system. For example, in the data center environment, the control system 100 can control the power state of a plurality of computing machines. In addition, or alternatively, the control system 100 can control the distribution of load within the data center. Alternatively, or in addition, the control system can control whether computations are performed at the data center or at some other location(s) (such as at one or more client devices), or both at the data center and some other location(s). Alternatively, or in addition, the control system can control cooling (and heating) applied within the data center, and so on. In a manufacturing environment, the control system 100 can control the manner of operation of manufacturing equipment or the like. No limitation is placed on the manner in which the control system 100 may control the target system.

The control system 100 can include one or more control units (CUs), such as representative control unit 102. All of the control units are constructed based on the same architecture. In other words, all of the control units include a collection of components specified by a common design template. (Although any individual control unit can omit one or more components specified in the design template.) Further, all of the control units operate based on a common protocol. (Although any individual control unit can provide specialized functions that operate within the encompassing context of the common protocol). Because of this commonality, the control system 100 can be said to replicate symmetric control functionality.

FIG. 1 indicates that different sites (e.g., geographical locations) can provide one or more control units. For example, location A may correspond to a data center that provides a first collection of control units. Location B may provide another collection of control units (not shown). Location n may provide another collection of control units (not shown). Considered all together, control system 100 can be viewed as a directed graph of control units. The nodes in the directed graph correspond to the control units. The edges correspond to communication links between the control units.

No limitation is placed on the manner in which control units can be connected. Further, no limitation is placed on the manner in which control units may cooperate once connected. For example, in certain environments, the control system 100 can organize and operate the control units in a hierarchical fashion. In other environments, the control system 100 can organize and operate the control units in a distributed peer-to-peer manner In other environments, the control system 100 can organize and operate the control units using a hybrid type of control scheme, e.g., incorporating elements of a hierarchical control scheme and a peer-to-peer control scheme.

The control units at a particular location provide control functionality that is specifically tailored to satisfy control objectives that are pertinent to that location. Further, each location may deploy control units to govern different aspects of its operations within different respective subsystems. For example, as will be described in greater detail below, a data center may deploy control units at different respective levels, such as a data center level, a container level, a rack level, a machine level, etc. The control units at a particular level provide control functionality that is specifically tailored to satisfy control objectives that are pertinent to that level.

To cite one example, a first control unit may be associated with a data center as a whole. This control unit may provide control functionality which attempts to minimize energy consumption while meeting customer demand in a timely fashion. A lower level control unit may be associated with an individual rack of computing machines. That control unit may attempt to satisfy other goals, such as the effective management of a cooling system which affects the rack, in addition to minimizing energy consumption while meeting customer demand in a timely fashion. Further, the control units at different levels may operate based on different timing specifications. For example, a control unit at a first level can provide control on a per-minute basis, while a control unit at a second level can provide control on a per-second basis (to cite merely one example).

The above-described versatility of the control unit stems, in part, from its extensible design, as will be explained in greater detail below. To begin with, FIG. 1 shows that the illustrative control unit 102 includes a collection of common components specified by the common design template. In one example, the components include: learning functionality 104; decision functionality 106; sensor processing functionality 108; actuator processing functionality 110; and event processing functionality 112. As mentioned, an individual control unit can omit one or more of these components. For example, an individual control unit can omit the learning functionality 104 if this function is not being used to control a particular portion of the target system. FIG. 3 (to be discussed in Section A.2) provides additional details regarding one implementation of a control unit. Further, other implementations of the control system 100 can connect the various modules together in different ways compared to that shown in FIG. 1 (and FIG. 3, to be described below).

From bottom up, the actuator processing functionality 110 controls one or more actuators associated with a particular domain or subsystem of the target system. The actuators, in turn, perform some control operation that affects the target system, such as by turning machines on and off, controlling a cooling system, etc. The sensor processing functionality 108 receives sensor information from one or more sensors associated with a particular domain or subsystem of the target system. The sensors collect any type of sensor information, such as performance counter information, temperature readings, etc.

The event processing functionality 112 operates as an information exchange/correlation center within the control unit 102, e.g., by receiving sensor information from the sensor processing functionality 108 and for routing commands to the actuator processing functionality 110. The event processing functionality 112 also optionally performs data processing operations on the information that is routed through it. In performing these roles, the event processing functionality 112 helps reduce the processing burden placed on other components of the control unit 102. And it can perform these functions with high throughput, thus contributing to the efficiency of the control unit 102, and the control system 100 as a whole. The event processing functionality 112 can also optionally provide interaction between the control unit 102 and one or more other control units in the control system 100.

The decision functionality 106 makes decisions regarding the control of the target system. By way of overview, the decision functionality 106 operates by accepting a goal or goals. Each goal describes a performance objective to be achieved or a state to be maintained by the control unit 102, such as the reduction of energy costs. The decision functionality 106 also receives one or more inputs (correlated to the goal or goals) which characterize the current state of the target system, e.g., as gleaned from the sensor information and other possible sources. Based on this input information, the decision functionality 106 performs control analysis and generates one or more outputs. The outputs may include commands which instruct the local actuator processing functionality 110 to makes appropriate changes to the target system. The outputs may also comprise decisions that are received and potentially acted upon by other control units.

The learning functionality 104 monitors the operation of the control unit 102 over a span of time. Based on this performance data and/or other dynamic factors, the learning functionality 104 can make any type of change to the control unit 102. The changes may affect one or more of the decision functionality 106, sensor processing functionality 108, and actuator processing functionality 110, etc. To repeat, Section A.2 will provide more detailed information regarding each of the modules described above, according to one illustrative implementation.

The architecture of the control unit 102 treats one or more of the above-summarized modules as pluggable or replaceable. One or more mechanisms may contribute to the pluggable characteristics of the modules. According to one mechanism, a user can physically replace any of the above-described modules with a new module. For example, assume that a current version of the decision functionality 106 executes a control operation according to algorithm A. The user can physically replace that functionality with another module that uses an algorithm B.

Alternatively, or in addition, the user can change the operation of any module described above by changing policy information which is fed to the module. In general, policy information provides instructions (e.g., declarative instructions) which configure the control unit 102 to operate in a specified manner. For example, a first version of the policy information may feed goal A to the decision functionality 106. The user can change the operation of the decision functionality 106 by feeding a second version of the policy information to the decision functionality 106, e.g., where that second version may identify goal B.

Considered as whole, the control system 100 of FIG. 1 allows a user (e.g., a design engineer or an administrator) to quickly change the control system 100 to meet changing needs within the target system. For example, assume that the target system corresponds to group of data centers that is experiencing increasing demand for its services. The user can expand the control system 100 by including one or more control units for new data centers or new racks within existing data centers, etc. Different control objectives may pertain to the new control units. If so, the user can insert appropriate pluggable modules into the new control units and/or adjust the policy information which governs the new control units.

Other optional features of the control system 100 contribute to the ease with which it can be deployed and its flexibility in operation. Four illustrative features are enumerated below. The control system 100 can adopt one or more of these features.

Approximate State. In one implementation, the decision functionality of a control unit issues instructions to its actuators without explicitly verifying that the actuators have implemented the commands (or correctly implemented the commands). In other words, the decision functionality may not receive express confirmation from an actuator that the actuator has carried out a command that was sent to it. In lieu of such express confirmation, the decision functionality can receive sensor information collected by the sensors; the sensor information indicates whether control objectives are being met or not. If control objectives are not being satisfied, the decision functionality can reseed appropriate instructions to the actuators. In view of these provisions, the control system 100 controls the target system based on the approximate state of the target system. This manner of control reduces the complexity of the control system 100.

Loose Coupling. In one implementation, the control system 100 can consider the sensor information that it collects as accurate but potentially incomplete. In other words, the control system 100 accepts the possibility that it may not collect all of the sensor information that it otherwise would collect under ideal conditions. The control system 100 can address this situation in various environment-specific ways. For example, the control system 100 can assume that a steady state condition applies when it fails to receive a sensor measurement (essentially treating the missing sensor measurement as the same as the last received sensor measurement). Or the control system 100 can interpolate a missing sensor measurement using a collection of received measurements, and so on. This feature also simplifies the construction of the control system 100.

Declarative Instructions. In one implementation, the modules of the control units are constructed in such a way that, whenever possible, controlling parameters are abstracted from core processing logic. This allows the user to more readily change the operation of the modules by passing declarative instructions to the modules (as opposed to changing the logic of the code used by the modules). For example, the user can pass these declarative instructions to the modules within the policy information. In one case, an external file (or files) can be used to express the policy information, e.g., as expressed in an XML format or any other format.

Distributed Control. In another implementation, the control system 100 can allow each control unit to determine what inputs are appropriate to govern its manner of operation. For example, the decision functionality 106 of a particular control unit can “publish” information regarding its decisions (and instructions). That same decision functionality 106 can also subscribe to various inputs. Some of these inputs may pertain to sensor information provided by its own local control unit. Other inputs may pertain to publications provided by other control units. In one implementation, the policy information can configure the decision functionality 106 of a particular control unit to accept certain inputs and to provide certain outputs. Further, the learning functionality 104 can guide the decision functionality 106 in selecting inputs and generating outputs.

By virtue of the distributed control, a first control unit need not have knowledge of the other control units that are consuming its publications. Further, a control unit which receives a particular instruction from another control unit need not carry out that instruction. For example, the decision functionality 106 (of a control unit A) can publish a request that invites other control units to accept load that cannot be effectively handled by control unit A. Assume that a control unit B, which is a peer of control unit A, subscribes to the publications of control unit A, and therefore receives the request to transfer load. The decision functionality 106 of control unit B may be governed by differing control objectives than control unit A; for example, control unit B may place a high priority on providing timely service to customer requests. That is, control unit B may impose stringent latency demands. As such, the decision functionality 106 of control B unit may decline to act on the instruction sent by control unit A.

The above manner of distributed control is more flexible than providing a master “hardwired” control scheme. For example, the distributed control of the control system 100 can better accommodate unforeseen control scenarios, e.g., by allowing individual control units to dynamically adapt to these scenarios based on prevailing local considerations. A hardwired control scheme may address an unanticipated scenario by forcing the execution of inappropriate instructions. This, in turn, may lead to bottleneck conditions or other negative results, e.g., where individual components are over-tasked, and other components are under-tasked.

FIG. 2 shows one particular application of the control system 100 shown in FIG. 1. In this example, the control system 100 is being used to control the operation of two data centers, namely, data center A 202 and data center B 204. Data center A 202 includes a plurality of control units, including a data center control unit 206 (which controls the operation of the data center as a whole). The data center A 202 also includes a plurality of container control units (e.g., container control units 208, 210, and 212) that control the operation of individual respective containers within the data center A 202. The data center A 202 also includes a collection of rack control units that control the operation of individual respective racks within the data center A 202. Although not shown, the data center A 202 can also include machine control units that control the operation of individual computing machines (e.g., servers) in the racks. Data center B 204 can include a similar array of control units deployed at respective levels, such as a data center control unit 214 which controls the operation of data center B 204 as a whole.

The example shown in FIG. 2 represents just one way of organizing control units. For instance, in another case, one or more “higher”-level control units (not shown) can provide control that affects the control of both data center A 202 and data center B 204. That overarching control unit, for instance, can receive tariff information as an input. Based thereon, that control unit can provide instructions which attempt to transfer load away from higher-cost jurisdictions to lower-cost jurisdictions.

To conclude this introductory section, consider the following two examples of the operation of the control system 100. A first example presents a top-down manner of control. Assume that data center A 202 is currently being run using solar power. As night approaches, decision functionality within the data center control unit 206 concludes that it is about to lose its power source. The data center control unit 206 thus publishes a request for other data centers to assume some or all of its processing load. Assume that data center B 204 agrees to take some of this load. Decision functionality associated with the data center control unit 214 then communicates with “subordinate” control units (not shown) to implement the transfer of load from the data center A 202 to data center B 204. Each subordinate control unit in data center B 204 can then perform an appropriate action, e.g., by turning on computing machines, etc.

A second example presents a bottom-up manner of control. In this case, assume that the container control unit 208 associated with a particular container within data center A 202 detects that its computing machines are about to exceed a power threshold (as defined by the policy information). If the container control unit 208 concludes that it does not have a supplemental source of power, it can interact with “higher”-level control units, such as the data center control unit 206. The data center control unit 206 may decide that the overburdened container should shed some of its load to stay below the power threshold. The data center control unit 206 can then communicate with other control units (e.g., container control units 210, 212) to investigate whether other containers can accommodate some of the load of the overburdened container.

The control system 100 handles these scenarios without “hardwiring” master logic into the control unit 102. That is, each control unit is configured to accept certain inputs; then, based on local considerations, the control unit takes a course of action which it deems appropriate. Desired overall control is provided through the collective effects of these types of distributed decisions.

A.2. Illustrative Implementation of a Control Unit

Advancing to FIG. 3, this figure shows, without limitation, one implementation of a control unit 302 that can be used in the control system 100 of FIG. 1. The control unit 302 controls a target system 304. More specifically, the control unit 302 may control a particular portion (or domain or subsystem) within a more encompassing target system 304. Other control units (not shown) may control other aspects of the target system 304.

To begin with, a collection of sensors 306 monitor various conditions in the target system 304. The particular group of sensors 306 with which the control unit 302 interacts is governed, in part, by the function that the control unit 302 serves within the target system 304, e.g., whether the control unit 302 is performing a “high”-level or “low”-level control function. (More generally, FIG. 3 shows that the sensors 306 are part of the target system 304 itself; but these sensors 306 can alternatively be conceptualized as part of the control system 100.)

Generally, the sensors 306 can measure any type of quantity to provide sensor information. Some types of sensors can provide individual readings. Alternatively, or in addition, other types of sensors can provide aggregate-type readings, such as by providing measurements obtained from a collection of computing machines. Some types of sensors can provide relatively low-level readings relating to the operation of machines, such as temperature information, humidity information, power consumption information, performance counter information, etc. Alternatively, or in addition, some sensors can provide higher-level information, such as weather information, financial information, etc. For example, a sensor can obtain high-level information from a Web Service or the like.

The sensors can be conceptualized as including a measurement component and an abstraction component. The measurement component obtains raw sensor information, such as by obtaining a temperature reading from a thermal gauge or a count value from a performance counter, etc. The abstraction component conditions the sensor information for receipt by the control unit 302.

At least one sensor service module 308 receives the sensor information from the sensors 306. In general, the sensor service module 308 acts as a conduit for forwarding the sensor information to an event processing module 310. For example, the sensor service module 308 can periodically poll the sensors 306 to collect the sensor information. The sensor service module 308 can then forward the sensor information to the event processing module 310.

Generally, the sensor service module 308 accommodates the introduction of different types of sensors (and different instances of a sensor of a particular type). It achieves this characteristic, in part, by providing uniform functionality for handling many tasks that would otherwise be separately performed by individual sensors. Sensors which interact with the sensor service module are asked to conform to a standard interface provided by the sensor service module 308.

Further, the sensor service module 308 is a pluggable unit. A user can reconfigure an existing sensor service module or replace it with a new sensor service module that is deemed more appropriate for interacting with a certain group of sensors. Further, the control system 100 can accommodate plural sensor service modules for interacting with different respective groups of sensors.

A collection of actuators 312 control various aspects of the target system 304. The particular group of actuators 312 with which the control unit 302 interacts is governed, in part, by the function that the control unit 302 serves within the target system 304, e.g., whether the control unit 302 is performing a “high”-level or “low”-level control function. (More generally, FIG. 3 shows that the actuators 312 are part of the target system 304 itself; but these actuators 312 can alternatively be conceptualized as part of the control system 100.)

Generally, the actuators 312 can control any aspect of the target system 304. Illustrative actuators include switches for turning machines on and off (or, more generally, for placing the machines in any type of power state), motors that control cooling fans, threading factors for controlling load balancers, and so on. More specifically, a first type of actuator can control a single component in the target system 304 (such as a single computing machine), while another type of actuator can control multiple components (such as a rack of computing machines).

The actuators 312 can be conceptualized as including a control component and an abstraction component. The control component carries out an actual control operation, such as by advancing a step motor. The abstraction component enables an actuator to interact with the control unit 302, e.g., by translating instructions from the control unit 302 to a form that is understandable by the actuator.

Actuator processing functionality 314 operates to forward commands from the event processing module 310 to the actuators 312. The actuator processing functionality 314 can include at least one actuator service module 316 and an actuator manager module 318. In one implementation, the actuator processing functionality 314 uses a push model, in which a decision module 320 pushes out commands to the actuator service module 316 via the actuator manager module 318. In other cases, the actuator processing functionality 314 can employ a pull model, or a combination of a push and pull models.

The actuator service module 316 performs a function that is the counterpart of the sensor service module 308. For example, the actuator service module 316 provides uniform functionality that handles many processing tasks that would otherwise be separately performed by individual actuators. Actuators which interact with the actuator service module 316 are asked to conform to a standard interface provided by the actuator service module 316.

Further, the actuator service module 316 is a pluggable unit. A user can reconfigure an existing actuator service module 316 or replace it with a new actuator service module 316 that is deemed more appropriate for interacting with a certain group of actuators. Further, the control unit 302 can accommodate plural actuator service modules for interacting with different respective groups of actuators.

The actuator manager module 318 facilitates the transfer of commands between the decision module 320 and the actuator service module 316. This alleviates the need for the decision module 320 to directly interact with the actuator service module 316. This aspect, in turn, simplifies the interface that the decision module 320 maintains with actuators, e.g., by abstracting away tracking functionality that would otherwise be performed by the decision module 320. In operation, the actuator manager module 318 acts as a combination of a lookup service and a proxy.

The event processing module 310 acts as a central processing station for information sent to the decision module 320, such as sensor information. The event processing module can optionally also receive and forward output information provided by the decision module 320, such as commands sent to the actuators. Further, the event processing module 310 handles communication with other control units; that is, the event processing module 310 can couple to other event processing modules of other respective control units.

In addition to routing, the event processing module 310 can perform various operations on the information that it receives, such as various types of filtering, aggregating, and correlating operations, potentially across multiple streams of information. To perform this function, the event processing module 310 can optionally include Complex Event Processing (CEP) functionality, such as, but not limited to, StreamInsight™ functionality provided by Microsoft® Corporation of Redmond, Wash.

According to one implementation, the decision module 320 constitutes the center of control provided by the control unit 302. By way of overview, the decision module 320 can receive goals that define any combination of cost-related objectives, power-related objectives, reliability-related objectives, performance-related objectives, and so on. In one example, the decision module 320 can receive these goals via a service level agreement (SLA) or the like, as specified by the policy information. The decision module 320 can also receive sensor information from the sensors 306. The decision module 320 can also receive other inputs, such as control instructions (or control “suggestions”) forwarded by other control units, etc.

In one implementation, the event processing module 310 is a pluggable unit. A user can reconfigure an existing event processing module 310 or replace it with a new event processing module that is deemed more appropriate for providing routing and data processing at a particular level (or subsystem) of the target system 304.

According to one mode of operation, the decision module 320 subscribes to receive certain inputs. The decision module 320 can be instructed to make these subscriptions, in turn, by the policy information. In one implementation, in response to the subscriptions, the event processing module 310 sends appropriate input information to the decision module 320 as its arrives, or in batches, etc. By virtue of receiving information by subscription, the decision module 320 may receive only a subset of the information that is provided to the event processing module 310.

In response to these inputs, the decision module 320 can determine one or more actions to take that promote a desired control objective(s). The decision module 320 can formulate commands which convey the actions to be taken. The decision module 320 can perform this analysis on any basis, such as on a periodic basis that is defined by the policy information.

Moreover, the decision module 320 is a pluggable unit. A user can reconfigure an existing decision module or replace it with a new decision module that is deemed more appropriate for providing control at a particular level (or subsystem) of the target system 304.

The decision module 320 can use any tool to provide its controlling function. For example, the decision module 320 can use a fuzzy logic engine that receives declarative input. That is, the decision module 320 can receive a control policy that declaratively outlines the desired behavior of the control unit 302 and/or the constraints within which it is to operate. This policy information can be defined in a syntax that can be loaded and parsed by the fuzzy logic engine. The fuzzy logic engine can then reason over this policy, given the sensor information provided by the event processing module 310. In response, the fuzzy logic engine can formulate actuator commands that are passed to the actuator manager module 318.

The use of the above-described approach may have one or more potential merits. For instance, the use of declarative instructions reduces the burden of writing customized code to implement different control scenarios. This, in turn, expedites deployment of new control strategies. Further, the use of fuzzy logic relaxes the modeling requirements, and also accommodates contradictory control objectives (such as an effort to minimize power consumption while maximizing resource utilization). Other implementations of the decision module 320 can use other types of tools to provide control (e.g., besides, or in addition to, fuzzy logic functionality). For example, the decision module 320 can use an artificial intelligence tool, a neural network tool, a statistical analysis tool, and so on.

Finally, a learning module 322 analyzes the operation of the control unit 302 (and, potentially, other aspects of the control system 100 as a whole). The operation of the control unit 302 can be expressed by one or more dynamic factors which represent the performance of the control unit 302. In response, the learning module 322 may make (and/or suggest) corrective changes to the control unit 302 (and, potentially, to other aspects of the control system 100). The changes may include changes to the policy information, control algorithms, etc., and may involve changing any one or more of information (e.g., controlling parameters, declarative instructions, etc.), software, hardware, etc. For example, the learning module 322 can recommend that a decision engine of a first type be replaced with a decision engine of a second type to address a new pattern of customer demand that is observed over a recent time span. Alternatively, or in addition, the learning module 322 can recommend that the control unit 302 make changes to the type and/or quantity of load that it handles. Generally, these changes allow the control system 100 to evolve over time to accommodate new trends in sensor information, new control objectives, new patterns in customer demand, and so on.

In one case, the learning module 322 can include one or more submodules for performing different types of analyses. Representative submodules can include: a prediction module for predicting future workload; an evaluation module for evaluating data collected by the event processing module 310; an evaluation module for evaluating the effectiveness of the decision module 320 and its underlying models, and so on.

For example, the learning module 322 can monitor the accuracy of the model provided by the decision module 320. When the accuracy falls below a defined threshold, the learning module 322 can replace the existing model with a potentially more accurate model. In other cases, the decision module 320 can perform analysis using two or more models, which operate in parallel. The learning module 322 can determine which of the models provides more accurate results, and selectively promote the use of that more effective model.

In one implementation, the learning module 322 is a pluggable unit. A user can reconfigure an existing learning module or replace it with a new learning module that is deemed more appropriate for providing analysis at a particular level (or subsystem) of the target system 304.

To conclude, the control unit of FIG. 3 provides one implementation of the more generally-depicted control unit 102 of FIG. 1. That is, the actuator processing functionality 110 of FIG. 1 can be implemented by the actuator processing functionality 314 of FIG. 3; the sensor processing functionality 108 of FIG. 1 can be implemented by the sensor service module 308 of FIG. 3; the event processing functionality 112 of FIG. 1 can be implemented by the event processing module 310 of FIG. 3; the decision functionality 106 of FIG. 1 can be implemented by the decision module 320 of FIG. 3; and the learning functionality 104 of FIG. 1 can be implemented by the learning module 322 of FIG. 3.

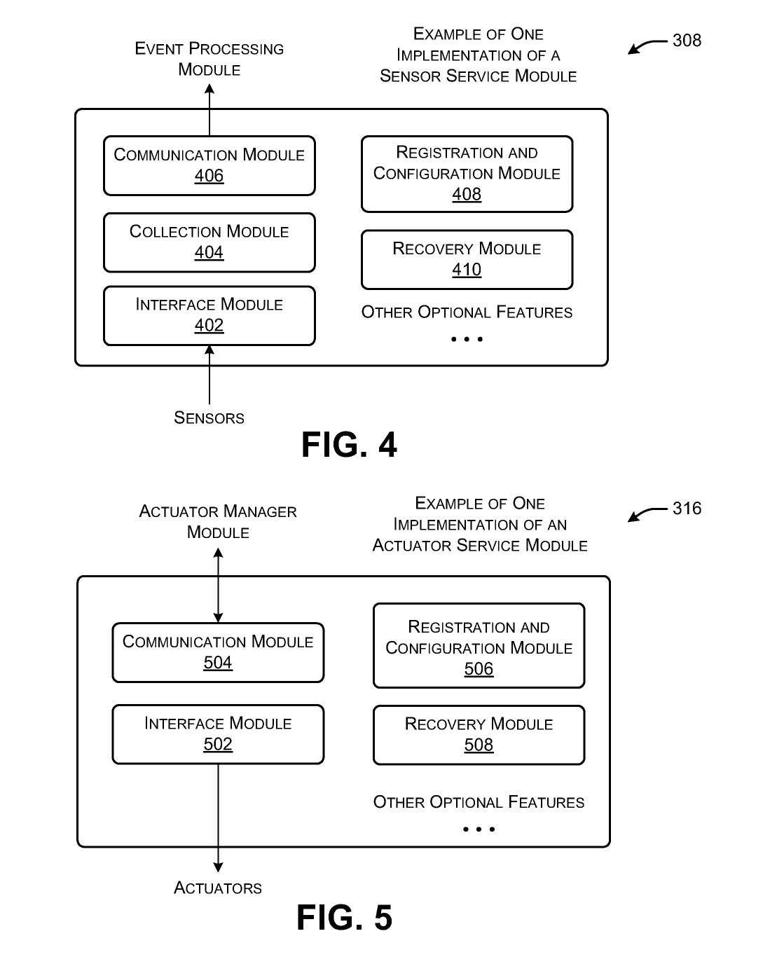

FIG. 4 shows additional details of one implementation of the sensor service module 308 of FIG. 3. The sensor service module 308 may include an interface module 402 for interfacing with the sensors 306. More specifically, the sensor service module 308 can provide a standard interface to which all sensor software abstractions are asked to adhere. This enables the sensor service module 308 to interact with different types of sensors.

A collection module 404 collects sensor information from the sensors 306 and buffers it ahead of sending it to the event processing module 310. In one case, the sensor service module 308 can adopt a push model of data collection, e.g., where it proactively collects sensor information from the sensors 306 and pushes that information to the event processing module 310. In other cases, the sensor service module 308 can employ a pull model, or a combination of a push and pull models.

A communication module 406 can send the collected sensor information to the event processing module 310. It can perform this task by serializing the sensor information and pushing it out to the event processing module 310.

A registration and configuration module 408 can register the sensors with which the sensor service module 308 is communicating. This allows the decision module 320, via the event processing module 310, to discover and subscribe to sensors of interest. The registration and configuration module 408 can also configure the interface module 402, e.g., by instantiating appropriate objects of the interface module 402 when new sensors are added to the control system 100. To facilitate this task, each sensor type may be represented by a class in an assembly Dynamic Link Library (DLL).

A recovery module 410 can attempt to restart a data collection process when the process fails with respect to a particular sensor. This task reduces the complexity of the sensor abstraction (of the sensor), which would otherwise be tasked with this responsibility.

FIG. 5 shows additional details of one implementation of the actuator service module 316 of FIG. 3, which is the counterpart of the sensor service module 308. The actuator service module 316 may include an interface module 502 for interfacing with the actuators 312. More specifically, the interface module 502 can provide a standard interface to which all actuator software abstractions are asked to adhere. This enables the actuator service module 316 to interact with different types of actuators.

A communication module 504 allows the actuator service module 316 to communicate with the actuator manager module 318 over a communication channel on behalf of the registered actuators 312. Further, the communication module 504 accepts commands from the actuator manager module 318 that are directed to those actuators 312.

A registration and configuration module 506 takes note of all registered actuators within a given actuator service instance. The registration and configuration module 506 can also configure the interface module 502, e.g., by instantiating appropriate objects of the interface module 502 when new actuators are added to the control system 100. To facilitate this task, each actuator type may be represented by a class in an assembly DLL.

A recovery module 508 can attempt to restart an actuator control process when the process fails with respect to a particular actuator. This task reduces the complexity of the actuator abstraction (of an actuator), which would otherwise be tasked with this responsibility.

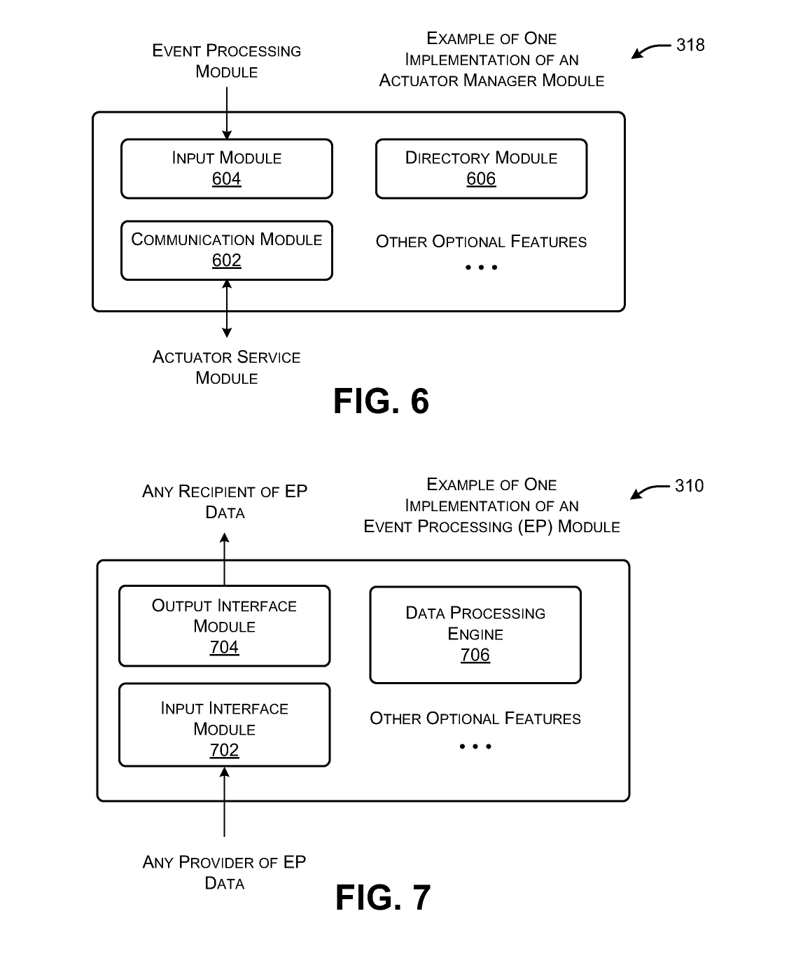

FIG. 6 shows one implementation of the actuator manager module 318. The actuator manager module 318 includes a communication module 602 for interacting with the actuator service module 316. The communication module 602 provides a communication channel that is established upon the introduction of a particular actuator service instance (e.g., a particular actual service module).

The actuator manager module 318 also includes an input module 604 for receiving parameterized actuator commands from the decision module 320. The actuator manager module 318 routes those commands to the actuator service module 316 via the established communication channel.

The actuator manager module 318 can also include a directory module 606. The directory module 606 maintains a lookup service that registers actuators associated with the actuator service module 316 (or more generally, that registers actuators associated with each actuator service instance). In response to control commands from the decision module 320, the directory module 606 performs appropriate lookup and routes the commands to an appropriate actuator service module, via an appropriate communication channel.

FIG. 7 shows one example of the implementation of the event processing module 310 of FIG. 3. The event processing module 310 includes an input interface module 702 that is configured to receive input information from any provider, e.g., by receiving sensor information from the sensor service module 308. In one case, the event processing module 310 is implemented as complex event processing (CEP) functionality; here, the input interface module 702 can be implemented by input adapter functionality.

The event processing module 310 also includes an output interface module 704 for providing output information to any recipient, e.g., by providing commands to the actuator processing functionality 314. In one case, the output interface module 704 can be implemented by output adaptor functionality provided by CEP functionality.

The event processing module 310 can also include a data processing engine 706. The data processing engine 706 can optionally perform any type of operation on the information that is passing through the event processing module 310. For example, as stated above, the data processing engine 706 can perform various types of filtering, aggregating, and correlating operations, potentially across multiple streams of information. In one implementation, the data processing engine 706 can perform these operations using CEP queries, which correspond to SQL-like operations that apply to incoming events, transforming them to output events which are fed to corresponding output adapters.

B. Illustrative Processes

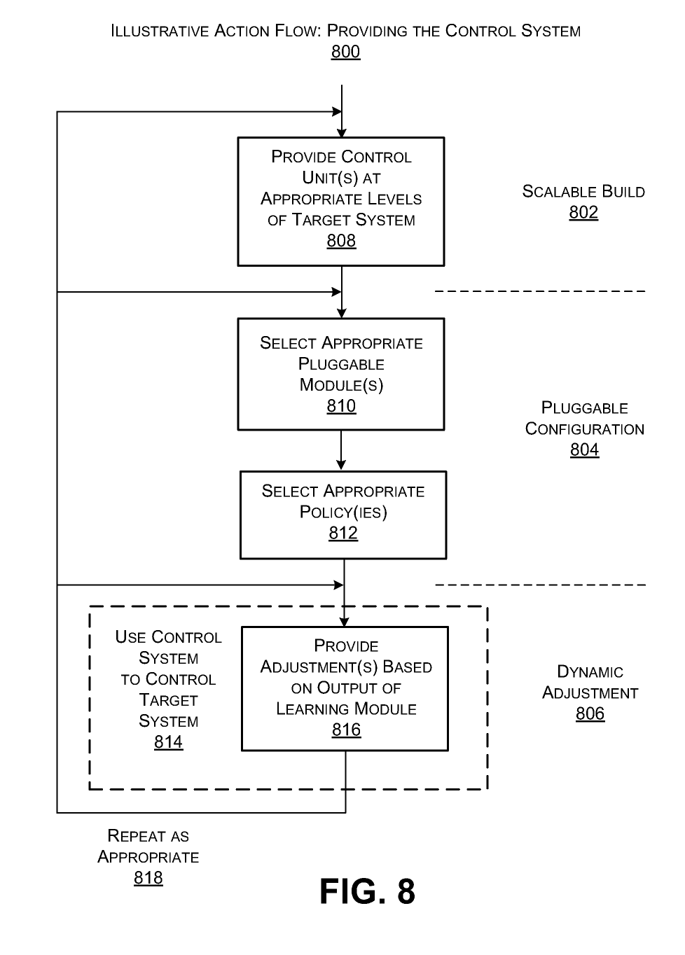

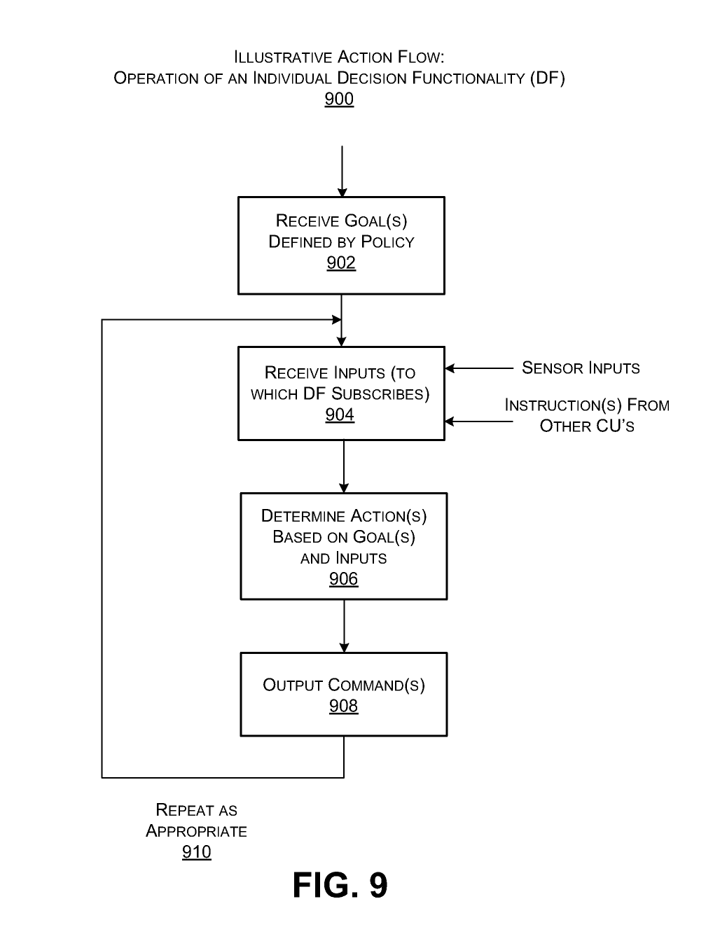

FIGS. 8 and 9 show procedures (800, 900) that explain the operation (and manner of use) of the control system 100 of Section A. Since the principles underlying the operation of the control system 100 have already been described in Section A, certain operations will be addressed in summary fashion in this section.

Starting with FIG. 8, this figure provides an overview of the manner in which the control system 100 can be deployed and maintained in a given control environment. The procedure 800 can be conceptualized as including three phases. In a first phase 802, a user (e.g., design engineer or administrator) deploys the physical equipment that implements the control system 100. In a second phase 804, the user can configure the control system 100. In a third phase 806, in the course of its operation, the control system 100 may undergo dynamic adjustment.

More specifically, in block 808, the user can provide appropriate control units at one or more locations associated with the target system. Further, at each particular location, the user may provide one or more control units at appropriate levels (or subsystems) of the target system.

In block 810, the user can optionally select the pluggable modules that will provide appropriate control for each deployed control unit. In block 812, the user can optionally specify appropriate policy information which governs the operation of the control units.

In block 814, the control system 100 that has been configured in the manner described above performs its control operation, e.g., by receiving sensor information and providing commands to actuators. In block 816, the learning functionality provided by the control system 100 can analyze the performance of the control system 100 and make appropriate adjustments to improve the performance.

Action 818 indicates that any of the above operations can be repeated for any reason. For example, a user may wish to repeat blocks 808, 810, and 812 to deploy and configure additional control units, e.g., to satisfy increased demand for a service provided by a data center. Block 816 can be repeated at regular intervals as the control system 100 performs its controlling operation.

FIG. 9 shows an illustrative procedure 900 that explains the operation of a control unit from the “perspective” of the decision functionality 106 (e.g., the decision module 320 of FIG. 3).

In block 902, the decision functionality 106 receives one or more goals specified by policy information. In one case, the policy information can convey this information in a declarative manner

In block 904, the decision functionality 106 receives various inputs, such as sensor information and/or instructions from other control units. In one case, as stated, the decision functionality 106 can receive the inputs to which it subscribes.

In block 906, the decision functionality 106 determines actions to take based on the received goals and inputs. In one case, the decision functionality 106 can use a fuzzy logic engine to perform this operation.

In block 908, the decision functionality 106 outputs one or more commands on the basis of conclusions reached in block 906.

Action 910 indicates that the decision functionality 106 can repeat the above-described operations over a span of time, such as at periodic intervals.

C. Representative Processing Functionality

FIG. 10 sets forth illustrative electrical data processing functionality 1000 that can be used to implement any aspect of the functions described above. With reference to FIGS. 1-3, for instance, the type of processing functionality 1000 shown in FIG. 10 can be used to implement any aspect of the control system 100, such as an individual control unit (102, 302). The processing functionality 1000 can also represent one or more parts of the target system being controlled, such as an individual server used in a data center. In one case, the processing functionality 1000 may correspond to any type of computing device that includes one or more processing devices.

The processing functionality 1000 can include volatile and non-volatile memory, such as RAM 1002 and ROM 1004, as well as one or more processing devices 1006. The processing functionality 1000 also optionally includes various media devices 1008, such as a hard disk module, an optical disk module, and so forth. The processing functionality 1000 can perform various operations identified above when the processing device(s) 1006 executes instructions that are maintained by memory (e.g., RAM 1002, ROM 1004, or elsewhere). More generally, instructions and other information can be stored on any computer readable medium 1010, including, but not limited to, static memory storage devices, magnetic storage devices, optical storage devices, and so on. The term computer readable medium also encompasses plural storage devices.

The processing functionality 1000 also includes an input/output module 1012 for receiving various inputs from a user (via input modules 1014), and for providing various outputs to the user (via output modules). One particular output mechanism may include a presentation module 1016 and an associated graphical user interface (GUI) 1018. The processing functionality 1000 can also include one or more network interfaces 1020 for exchanging data with other devices via one or more communication conduits 1022. One or more communication buses 1024 communicatively couple the above-described components together.

In closing, the description may have described various concepts in the context of illustrative challenges or problems. This manner of explication does not constitute an admission that others have appreciated and/or articulated the challenges or problems in the manner specified herein.

More generally, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A control system for controlling a target system, comprising:
at least two control units having symmetric functionality, each control unit comprising:
sensor processing functionality configured to receive sensor information;
actuator processing functionality configured to control at least one actuator associated with the target system; and
decision functionality configured to control the target system to achieve at least one goal specified by a policy, the decision functionality accepting at least one input and generating at least one output which promotes said at least one goal,
at least one of the decision functionality, sensor processing functionality, and actuator processing functionality corresponding to a pluggable module.

2. The control system of claim 1, wherein said at least two control units are provided at different respective levels of at least one data center.

3. The control system of claim 2, wherein said at least two control units are selected from any of:
a control unit to control an individual machine in a data center;
a control unit to control a collection of machines in the data center;
a control unit to control the data center as a whole; or
a control unit to control two or more data centers.

4. The control system of claim 1, wherein said at least two control units are provided at at least two respective geographic locations.

5. The control system of claim 4, wherein said at least two control units are associated with at least two data centers at said at least two respective geographic locations.

6. The control system of claim 1, wherein different decision functionalities provided by different respective control units are governed by different respective local goals.

7. The control system of claim 1, wherein the pluggable module corresponds to a physically replaceable module, and wherein each control unit is configured to accept the pluggable module.

8. The control system of claim 7, wherein the pluggable module is also configured to accept changeable policy information.

9. The control system of claim 1, wherein each of the decision functionality, sensor processing functionality, and actuator processing functionality is a respective pluggable module.

10. The control system of claim 1, wherein at least one control unit further comprises learning functionality configured to dynamically adjust behavior of the control unit based on at least one dynamic factor.

11. The control system of claim 1, wherein each control unit further comprises event processing functionality configured to facilitate processing of information within the control unit.

12. A control unit for controlling a target system, comprising:
a sensor service module configured to receive sensor information from one or more sensors;
actuator processing functionality configured to control at least one actuator associated with the target system;
an event processing module configured to facilitate processing of information within the control unit and interaction of the control unit with at least one other control unit;
a decision module configured to control the target system to achieve at least one goal specified by a policy, the decision module accepting at least one input and for generating at least one output which promotes said at least one goal; and
a learning module configured to dynamically adjust behavior of the control unit based on at least one dynamic factor,
each of the learning module, decision module, event processing module, sensor service module, and actuator processing functionality corresponding to a respective pluggable module.

13. The control unit of claim 12, wherein the actuator processing functionality comprises:
an actuator service module configured to direct commands to said at least one actuator; and
an actuator manager module configured to maintain a directory of said at least one actuator associated with the actuator service module, to thereby facilitate transfer of commands from the decision module to said at least one actuator.

14. The control unit of claim 12, wherein each pluggable module corresponds to a physically replaceable module, and wherein the control unit is configured to accept the pluggable module.

15. The control unit of claim 14, wherein each pluggable module is also configured to accept changeable policy information.

16. The control unit of claim 12, wherein the target system corresponds to at least one data center, and wherein said at least one goal that governs the decision module pertains to an aspect of an operation of the data center.

17. A method for controlling at least one target system, comprising:
providing at least two control units to control at least two respective aspects of the target system, said at least two control units collectively comprising a control system, said at least two control units including symmetric functionality;
for each control unit, selecting pluggable modules for use in the control unit;
for each control unit, selecting policy information which defines at least one goal to be achieved by the control unit; and
using the control system to govern operation of the target system.

18. The method of claim 17, further comprising, using learning functionality to dynamically adjust configuration of the control system based on at least one dynamic factor.

19. The method of claim 17, wherein the target system is at least one data center.

20. The method of claim 19, wherein said providing comprises providing said at least two control units to control any of:
an individual machine in a data center;
a collection of machines in the data center;
the data center as a whole; or
two or more data centers.
